(19) United States
(12) Patent Application Publication
(10) Pub. No.: US 2006/0281658 A1
(43) Pub. Date: Dec. 14, 2006

(54) High water content liquid laundry detergent in water-soluble package

(76) Inventors: Kenneth E. Kellar, Flemington, NJ (US); Justyna Nicinska, Princeton, NJ (US)

Correspondence Address: CHURCH & DWIGHT CO., INC., LAW DEPT. - PATENTS, 469 NORTH HARRISON STREET, PRINCETON, NJ, 08543-5297, US

(21) Appl. No.: 11/147,609

(22) Filed: Jun. 8, 2005

(51) Int. Cl. C11D 17/00

(52) U.S. Cl. 510/438

(57) ABSTRACT

An article comprising an organic solvent free aqueous liquid laundry detergent at least about 35% by weight of water and an inorganic salt, an ionic surfactant, and a non-ionic surfactant which is contained in a package, preferably a pouch or packet containing a unit dose of said liquid laundry detergent, said package comprising a water-soluble film-forming material that dissolves when place in the laundry wash water so as to release the liquid laundry detergent, said water-soluble film-forming material being in substantially direct contact with the liquid laundry detergent, said film-forming material maintaining its structural integrity prior to addition to the laundry wash water due to the critical level of salt contained within the liquid laundry detergent, and wherein said individual pouches are stored within a water vapor impermeable container.

### BACKGROUND OF INVENTION

This invention relates to high water content liquid laundry detergents in unit dosage form in a package comprising a water-soluble, film-forming material.

The use of water-soluble film packages to deliver unit dosage amounts of laundry products is well known. Granular detergents and granular bleaches have been sold in this form on an irregular basis in the United States for many years.

A compact granular detergent composition in a water-soluble film pouch has been described in Japanese Patent Application No. 61-151032, filed Jun. 27, 1986. A paste detergent composition packaged in a water-soluble film is disclosed in Japanese Patent Application No. 61-151029, also filed Jun. 27, 1986. Further disclosures relating to detergent compositions which are either pastes, gels, or mulls packaged in water-soluble films can be found in Canadian Patent No. 1,112,534 issued Nov. 17, 1981; and European Patent Application Nos. 158464 and 234867, published Oct. 16, 1985, and Sep. 2, 1987, respectively. A liquid laundry detergent containing detergents in a water/propylene glycol solution is disclosed in U.S. Pat. No. 4,973,416. The presence of the organic solvent, however, results, inter alia, in a clear price disadvantage.

None of the above prior art disclosures relate to packaging a high-water content, organic solvent-free, liquid laundry detergent, particularly a phase-stable, homogeneous liquid laundry detergent, in a package consisting of a water-soluble, film-forming material which is in direct contact with the liquid laundry detergent.

It is generally believed that high water content liquid laundry detergents are incompatible with water-soluble films because of their water content. Thus, the attendant advantages of high water content liquid laundry detergents over other forms of laundry detergents such as granules, pastes, gels, and mulls have not been available in water-soluble unit dosage form. The advantages of liquid laundry detergents over granules, pastes, gels, and mulls include their aesthetic appearance and the faster delivery and dispersibility of the detergent ingredients to the laundry wash liquor, especially in a cool or cold water washing process.

### SUMMARY OF INVENTION

In accordance with the present invention, an article is provided for use in the laundry process which comprises a package comprising a water-soluble material in film form containing a liquid laundry detergent. More particularly, the article is an aqueous, organic solvent free, liquid laundry detergent contained in a package, preferably a pouch or packet, containing a unit dose of the liquid laundry detergent, the package comprising a water soluble film-forming material that dissolves when placed in the laundry wash water so as to release the liquid laundry detergent. According to the invention, the water-soluble film-forming material is in substantially direct contact with the liquid laundry detergent, with the film-forming material maintaining its structural integrity prior to addition to a laundry wash liquor. The liquid detergent is capable of remaining homogeneous over a relatively wide temperature range, such as might be encountered in storage, and the pouch is capable of dissolution in water even after extended storage.

The water-soluble package of this invention is preferably made from polyvinyl alcohol, but can also be cast from other water-soluble materials such as polyethylene oxide or methyl cellulose. Suitable water-soluble films are well known in the art and are commercially available from numerous sources.

The liquid laundry detergent for use in this invention is formulated in a manner which makes it compatible with the water-soluble film for purposes of packing, shipping, storage, and use. According to the instant invention, compatibility of the liquid laundry detergent with the water-soluble film is achieved by the use of a high concentration of an appropriate salt in the liquid laundry detergent. The liquid laundry detergent is a concentrated, heavy-duty liquid detergent which, as noted above, contains more than about 30% water, and preferably more than about 40% water, expressed as a percentage by weight of the overall detergent composition.

The liquid laundry detergent package itself can be of any configuration, but conveniently may have a rectangular or square shape when viewed normally to the plane of its two longest dimensions. A rectangular or square packet is more easily manufactured and sealed than other configurations when using conventional packaging equipment.

The invention is directed to formulations that are homogenous, contain a relatively high percentage of nonionic surfactant, contain a high concentration of salt, and have a high water content, without using organic solvents, gelling agents, thickening agents, clays, zeolites or solid material other than the precipitated nonionic surfactant. These formulations disperse and dissolve rapidly during the wash cycle.

The formulations are essentially homogenous (show no phase separation) for an extended time period and temperature range. They are not clear transparent liquids but are turbid and more like pastes or gels that have the consistency of meringue. The desirability of homogeneity of the formulations is mainly a product appearance issue, as phase separation may not be considered an attractive product property. However, phase separation could also be a product performance issue, since both phases in a phase-separated system may not disperse and dissolve rapidly during the wash cycle, although the formulation may have dispersed and dissolved rapidly before phase separation occurred.

As stated above, the formulations of the invention contain a large amount of salt, in particular potassium, sodium or ammonium carbonate, although other salts such as the respective hydroxide and sulfates, which may be characterized as being small, sphere-like, and relatively highly-charged, may also be used. Potassium carbonate, which is well known in the detergent art for its utility as a builder and a high pH buffer, is preferred. The high salt content allows the high water content detergent formulation to be compatible with the material from which the water-soluble pouch is constructed, for the water soluble films from which the pouches are formed are insoluble in a high salt concentration aqueous solution.

The formulations of the invention contain a relatively high percentage of nonionic surfactant, generally greater than about 17 percent. It is particularly advantageous for the nonionic surfactant to be present in an amount of at least 50% by weight based on the total weight of surfactant employed. As is understood by those skilled in the art, nonionic surfactants lower the critical micelle concentration, and achieve superior oil removal, and this preferred ratio of 50% nonionic surfactant to total surfactant present will also act to minimize phase separation within the pouch, as well as to enhance detergency, particularly in hard water.

An anionic surfactant, such as linear alkyl sodium sulfanates (LAS), would precipitate under the high salt content of the formulation that is necessary to achieve compatibility between the water-soluble pouch and the formulation. If only an anionic surfactant were present, then enough anionic surfactant could be added so that the volume of precipitate that formed would actually hide any separation occurring between the liquid and solid phases. However, if a nonionic surfactant were also present, the high salt content would cause the formation of two phases, each containing some of the nonionic surfactant. One phase would be poor in nonionic surfactant (but rich in water), and would most likely form a homogenous phase with any precipitated anionic surfactant. However, the other phase would be rich in nonionic surfactant (but poor in water), and would therefore have a density that is less than that of the first. Consequently, the less dense phase would eventually rise to the top of the formulation, yielding phase separation.

The formulations of the invention are homogenous, although they contain a relatively high percentage of nonionic surfactant, high salt content, and high water content, without using organic solvents, gelling agents, thickening agents, clays, zeolites or solid material other than the precipitated nonionic surfactant. Excluding organic solvents, gelling agents, thickening agents, clays, zeolites, or other solid material significantly reduces the cost of the formulation: Moreover, eliminating those solid components which do not contribute to detergency prevents the build up of these solid components on the material that is being washed, which is an important aspect with respect to cleaning.

The formulations contain a high percentage of water (greater than 30 percent and more preferably greater than 40 percent) and no propylene glycol. As stated above, the high percentage of water allows for a single-phase system to be prepared for formulations containing a combination of nonionic and anionic surfactants. The high percentage of water also results in the loose gel or loose paste (meringue) consistency or texture, which allows the formulation to readily disperse and dissolve during the wash cycle. The high percentage of water therefore gives both a product efficacy and a product cost advantage.

The formulations rapidly disperse and dissolve in wash cycle using cold water in 90 seconds or less, but typically in less than one minute. This is a product efficacy issue, since, for example, formulations involving pastes or gels do not disperse and dissolve rapidly during the wash cycle.

The present invention relies on an inorganic salt such as potassium carbonate to give compatibility between the water-soluble pouch and the formulation. The presence of the potassium carbonate in the formulation renders the pouch, consisting of polyvinyl alcohol and polyvinyl acetate, insoluble in the formulation. This results in compatibility between the pouch and the formulation. The potassium carbonate also causes the anionic surfactants in the formulation to precipitate and the nonionic surfactants to separate into two layers. The two layers include a lower surfactant-poor (water-rich) layer and an upper surfactant-rich (water-poor) layer. It is the upper surfactant-rich layer that would ultimately separate in the detergent formulation because this layer is effectively an “oily” layer, and is therefore less dense than the surfactant-poor aqueous layer. The invention prevents this phase separation by minimizing the volume of the surfactant-rich layer. This is accomplished by maximizing the amount of nonionic surfactant that is associated with the precipitated anionic surfactant by maximizing the anionic/nonionic surfactant ratio, and by making the water content of the formulation as high as possible. The surfactant ratio cannot, however, be too high, and the water content cannot be too low. Otherwise, a rigid, gel-type structure would form, and the resulting formulation would not dissolve or disperse during the wash cycle. Furthermore, the high water content of the formulations, in addition to allowing rapid dispersion and dissolution in the wash cycle, results in a significant cost reduction, thereby making a pouch-type detergent available to the consumer at a significantly lower price.

Example of a Stable, Homogenous, Formulation

The components of a stable, homogenous formulation prepared according to the invention is given in Table 1 below. The anionic surfactant is dodecylbenzene sulfonic acid (DBSA), which becomes the sodium salt in basic solution. The nonionic surfactant is nonylphenolnonaglycolether (NPE-9). The total surfactant content is 35%. The total water content, when taking into account the amount of water in each component (75% for Bitrex PG, 25%, for example), is 41%.

TABLE 1

| Component | Percent by Weight |
|---|---|
| 40% DBSA | 38.250 |
| | (Giving 15.3% DBSA) |
| Distilled Water | 18.577 |
| NPE-9 | 19.700 |
| Liquitint Dye Aquamarine, 1% | 1.100 |
| Potassium Carbonate, anhydrous | 19.470 |
| Polymer 445 | 0.279 |
| Oleic Acid | 0.928 |
| Brightener, UNPA 40% | 0.554 |
| Versene 100, 37% | 0.280 |
| Bitrex PG, 25% | 0.030 |
| Fragrance, Givoudan Expedience | 0.832 |
| UK020377/00 | |

If an analogous formulation were prepared with the identical contents of all components, except that the total water content were decreased to 39% and the potassium carbonate content were increased to 22.1% (to compensate for the lost water), such formulation would eventually show phase separation. If yet another analogous formulation were prepared, except that the content of NPE-9 were 22.4% and the content of DBSA were 12.6% (maintaining 35% total surfactant), such formulation would also eventually show phase separation. Consequently, the preparation of homogenous formulations is very dependent on the relative amounts of nonionic surfactant, anionic surfactant, potassium carbonate, and water, and appropriate ratios may be readily determined on a case-by-case basis.

Table 2 presents data for various detergent formulations prepared according to the invention and provides a guide to permit those skilled in the art to select appropriate ingredient ratios to form homogenous formulations. In addition, Table 2 presents stability data determined after centrifugation of a sample for 90 minutes at 1050 rpm. If no separation was noticed for this rapid-screening centrifuge test, which correlated well with stability at room temperature, the formulation was determined to be stable.

TABLE 2

| | | | | | Phase |
|---|---|---|---|---|---|
| Total | | | | | Stability |
| Surfactant | | | K₂CO₃ | | in |
| (%) | DBSA (%) | NPE-9 (%) | (%) | Water (%) | Centrifuge |
| 31.5 | 13.7 | 17.8 | 23.2 | 41.1 | Stable |
| 35.0 | 15.3 | 19.7 | 24.5 | 36.1 | Not Stable |
| 35.0 | 15.3 | 19.7 | 23.5 | 37.1 | Not Stable |
| 35.0 | 15.3 | 19.7 | 23.0 | 37.6 | Not Stable |
| 35.0 | 15.3 | 19.7 | 21.5 | 39.1 | Not Stable |
| 35.0 | 15.3 | 19.7 | 20.5 | 40.1 | Stable |
| 35.0 | 15.3 | 19.7 | 19.5 | 41.1 | Stable |
| 35.0 | 15.3 | 19.7 | 18.5 | 42.1 | Stable |
| 35.0 | 15.3 | 19.7 | 17.5 | 43.1 | Stable |
| 35.0 | 15.3 | 19.7 | 16.3 | 44.3 | Stable |
| 35.0 | 15.3 | 19.7 | 15.5 | 45.1 | Not Stable |
| 35.0 | 15.3 | 19.7 | 14.5 | 46.1 | Not Stable |
| 35.0 | 16.2 | 18.8 | 20.5 | 40.0 | Stable |
| 35.0 | 16.2 | 18.8 | 16.5 | 44.0 | Stable |
| 37.0 | 16.1 | 20.9 | 17.2 | 41.2 | Stable |
| 37.0 | 16.1 | 20.9 | 14.0 | 44.4 | Not Stable |
| 39.0 | 17.0 | 22.0 | 20.5 | 35.9 | Not Stable |
| 39.0 | 17.0 | 22.0 | 15.3 | 41.1 | Not Stable |
| 39.0 | 17.0 | 22.0 | 12.3 | 44.1 | Not Stable |
| 40.0 | 17.4 | 22.6 | 19.1 | 36.2 | Not Stable |
| 40.0 | 17.4 | 22.6 | 17.1 | 38.2 | Stable |
| 40.0 | 17.4 | 22.6 | 15.1 | 40.2 | Not Stable |

Since the water-soluble film is permeable to water vapor, the water of the detergent formulation inside the capsule will evaporate until the water activity of the detergent formulation becomes equal to the relative humidity external to the capsule. If the water content of the detergent formulation decreases to a certain level, the composition of the detergent formulation changes enough to cause phase separation. Similarly, if the relative humidity external to the capsule is greater than the water activity of the detergent formulation inside the capsule, water will be taken up by the detergent formulation, and this could also lead to phase separation Consequently, it becomes important to ensure that the relative humidity external to the capsule is equal to the water activity of the detergent formulation inside the capsule.

It is, therefore, a feature of the invention to use a secondary package to maintain an environment wherein the relative humidity of the region external to the capsule is equal to the water activity of the detergent formulation inside the capsule. This secondary packaging may be composed of aluminum foil or another material that has a low water vapor transmission rate. In addition to providing stability of the detergent formulation with respect to homogeneity, the secondary packaging also ensures that the water solubility of the film used to form the capsule is maintained such that the detergent capsule dissolves in the wash.

The utility of secondary packaging in connection with the storage of detergent containing sachets applies not only to the aqueous detergent formulations discussed above, but also applies to more traditional liquid laundry capsule formulations based on propylene glycol or other hydroscopic organic solvents. In formulations based on these organic solvents, water can be gained or lost by the formulations depending on the relative values of the water activity of the detergent formulation inside the capsule and the relative humidity of the environment outside the capsule. Depending on the water content, the ability of the detergent formulation to gain water content also depends on how hydroscopic the organic solvent is. For the traditional liquid laundry capsule formulations, the formulation-capsule incompatibility caused by an increase in water content can be prevented by keeping the liquid capsules within secondary packaging similar to that proposed in this invention.

As an example of the need for secondary packaging, it was found that a 500 g batch of formulation which contained 35% total surfactant, 15.3% DBSA, 19.7% NPE-9, 19.5% potassium carbonate, and 41.1% water, showed no phase separation when stored in a closed plastic container in an oven for almost 1 month at 122° F. However, this same formulation showed phase separation after only a few days when stored in the water-soluble capsule at 122° F.

Table 3 demonstrates the importance of maintaining the correct RH in the environment external to the slurry capsules. The pouches which are the subject of Table 3 were composed of a cast polyvinyl alcohol film, available commercially from Monosol LLC as M-8630, and were held in an oven at 122° F.

With respect to water loss or water gain, a formulation contained in a pouch is basically equivalent to a formulation left open to air. Consequently, secondary packaging, or a package containing the slurry capsules, is necessary to maintain the correct RH. Otherwise, water from the formulation will either be lost or gained, and this loss or gain will eventually lead to phase separation. It is also important that the secondary packaging be sealed, and not permeable to water vapor.

With respect to the secondary packaging, it may also be advantageous for it to be resealable (like a zip-lock) so that the consumer will find it easy to reseal the pouch and do so regularly. It is not as critical to avoid water permeability to water vapor at room temperature as it is at 122° F., but at room temperature the same trends will be observed.

TABLE 3

| | | Initial | 4 Days | % Wt. | |
|---|---|---|---|---|---|
| Pouch | Conditions | Wt. (g) | Wt. (g) | Change | Phase Separation |
| 1 | Heat sealed | 50.31 | 50.16 | −0.298 | Very small |
| | pouch | | | | |
| 2 | Desiccator, | 51.43 | 50.76 | −1.303 | Some separation |
| | 69% RH | | | | separation. |
| 3 | Desiccator, | 52.20 | 55.41 | +6.149 | No significant |
| | 82% RH | | | | |
| 4 | Left open, | 51.31 | 44.01 | −14.227 | Worst separation |
| | no cover | | | | of all Pouches. |
| 5 | Wide jar, | 51.24 | 50.99 | −0.488 | Similar to Pouch 1. |
| | closed top | | | | |

Other Considerations

The high-water laundry capsule formulations of the instant invention could potentially include solid performance-enhancing components such as powdered enzymes and zeolites, though these components are not necessary. The gel-like consistency of the formulations of the invention allows solid materials to be incorporated to form a homogenous mixture without the occurrence of settling. Furthermore, the cost of powdered enzymes is significantly less than that of liquid enzymes.

What is claimed is:

1. An article comprising (1) an organic solvent free aqueous liquid laundry detergent containing at least about 35% by weight of water; and (2) a salt selected from the group consisting of potassium, sodium and ammonium carbonate, hydroxide and sulfate and mixtures thereof, (3) at least about 17% by weight of a non-ionic surfactant and wherein the ratio of ionic surfactant to nonionic surfactant within said detergent is less than 0.5, and (4) a package for said aqueous liquid laundry detergent which is in direct contact with the aqueous liquid laundry detergent, wherein said package is formed from a water-soluble, film-forming material, and wherein said salt is present in a concentration sufficient to render said film-forming material insoluble with respect to the aqueous liquid laundry detergent contained within the said package.

2. The article of claim 1 wherein the water-soluble film-forming material is polyvinyl alcohol.

3. The article of claim 1 wherein the salt is potassium carbonate.

4. The article of claim 3 wherein the potassium carbonate is present in a concentration of at least about 15% by weight based on the total weight of the contents of the package.

5. The article of claim 4 wherein the surfactant content of the package exceeds 30% by weight, based on the total weight of the contents of the package.

6. The article of claim 5 wherein said article is stored prior to use in a water vapor impermeable secondary packaging.
